(19) United States
(12) Patent Application Publication
(10) Pub. No.: US 2024/0324085 A1
(43) Pub. Date: Sep. 26, 2024

(54) FRACTIONAL POWER LIGHTING SYSTEM

(71) Applicant: Fractional Power, LLC, Murray, UT (US)

(72) Inventor: Robert H. Burgener, II

(21) Appl. No.: 18/613,036

(22) Filed: Mar. 21, 2024

Related U.S. Application Data
(60) Provisional application No. 63/453,719, filed on Mar. 21, 2023.

(51) Int. Cl. H05B 47/16; H05B 39/09; H05B 45/44

(52) U.S. Cl. CPC H05B 47/16; H05B 39/09; H05B 45/44

(57) ABSTRACT

A lighting system includes a plurality of lamps configured to operate in an on mode and in an off mode. The plurality of lamps include C×N lamps, wherein C is a number of channels and N is a number of lamps per channel. The lighting system includes a plurality of electronic switches coupled to the lamps to switch the lamps between the on and off modes. A power source provides the lamps with operating power. A controller is electrically coupled to operate the electronic switches. The controller includes timing circuitry to control time each lamp is in the on mode and the off mode. Within a given time period, the amount of time each lamp is in the on mode is less than the amount of time each lamp is in the off mode. The frequency at which each lamp is in the on mode is at least 60 Hz.

### CROSS-REFERENCE TO RELATED APPLICATION

This application claims the benefit of U.S. Provisional Application No. 63/453,719, filed Mar. 21, 2023, entitled “FRACTIONAL POWER LIGHTING SYSTEM,” which application is incorporated herein by reference.

### BACKGROUND

The disclosure relates to a lighting system which operates from several lamps to hundreds of lamps in a pulsed “on” mode rather than a continuous “on” mode. The lighting system is configured to produce an equivalent amount of light operating the lamps in a pulsed “on” mode at a reduced operating power compared to operating the lamps in a continuous “on” mode.

### SUMMARY OF THE INVENTION

The disclosure relates to a lighting system having a plurality of lamps configured to operate in an on mode and in an off mode. In some embodiments, the plurality of lamps comprise C×N lamps, wherein C is a number of channels greater than 2 and N is a number of lamps per channel greater than 2.

In some embodiments, C is a number greater than 4.

In some embodiments, N is a number within the range of 4 to 12.

In some embodiments of the lighting system, the plurality of lamps comprise LED lamps. In some embodiments of the lighting system, the plurality of lamps comprise incandescent lamps.

In some embodiments, the lighting system includes a plurality of electronic switches, wherein each lamp is electrically coupled to a corresponding electronic switch. In some embodiments, the plurality of electronic switches comprise a field effect transistor (FET).

The lighting system includes a power source configured to provide each lamp with an operating power. The operating power comprises an operating current and an operating voltage. In some embodiments, the power source provides a light system operating power comprising a sum of the operating power provided to each lamp in a given time period.

The lighting system includes a controller electrically coupled to the electronic switches. In some embodiments, the controller comprises timing circuitry to control an amount of time each lamp is in the on mode and an amount of time each lamp is in the off mode. In some embodiments, within a given time period, the amount of time each lamp is in the on mode is less than the amount of time each lamp is in the off mode. In some embodiments, the frequency at which each lamp is in the on mode is at least 60 Hz.

In some embodiments of the lighting system, the controller is electrically coupled to the electronic switches via a hard wire connection.

In some embodiments of the lighting system, the controller is electrically coupled to the electronic switches via a wireless connection.

In some embodiments, the controller directs each of the C channels in parallel to sequentially operate the N lamps within each channel in the on mode and in the off mode.

In some embodiments, within a given time period, the amount of time each lamp is in the on mode is less than 20% the amount of time each lamp is in the off mode.

In some embodiments, within a given time period, the amount of time each lamp is in the on mode is less than 15% the amount of time each lamp is in the off mode.

In some embodiments, within a given time period, the amount of time each lamp is in the on mode is less than 10% the amount of time each lamp is in the off mode.

In some embodiments, within a given time period, the amount of time each lamp is in the on mode is less than 5% the amount of time each lamp is in the off mode.

In some embodiments, the frequency at which each lamp is in the on mode is in the range of 60 Hz to 1000 Hz. In some embodiments, the frequency at which each lamp is in the on mode is about 60, 100, 200, 300, 400, 500, 600, 700, 800, 900, 1000, 1100 Hz, or more, where any of the stated values can form an upper or lower endpoint of a range.

In some embodiments, each lamp comprises a rated power comprising a rated current and a rated voltage and wherein the operating power exceeds the rated power.

In some embodiments, the lighting system operates at a power savings of 30%.

In some embodiments, the lighting system operates at a power savings of 40%.

In some embodiments, the lighting system operates at a power savings of 50%.

In some embodiments, the lighting system operates at a power savings of 60%.

In some embodiments, the lighting system operates at a power savings of 70%.

In some embodiments, the lighting system operates at a power savings of 80%.

In some embodiments, the lighting system operates at a power savings of 90%.

Various embodiments are described herein. It will be understood that the embodiments described herein may be combined not only as listed, but in other suitable combinations in accordance with the scope of the invention.

It is to be understood that both the foregoing general description and the following detailed description are examples and explanatory and are not restrictive of the invention, as claimed. It should also be understood that the embodiments may be combined, or that other embodiments may be utilized and that structural changes, unless so claimed, may be made without departing from the scope of the various embodiments of the present invention. The following detailed description is, therefore, not to be taken in a limiting sense.

### BRIEF DESCRIPTION OF THE DRAWINGS

In order that the manner in which the above-recited, and other features and advantages of the invention are obtained will be readily understood, a more particular description of the invention briefly described above will be rendered by reference to specific embodiments thereof that are illustrated in the appended drawings. Understanding that these drawings depict only typical embodiments of the invention, and are not, therefore, to be considered to be limiting of its scope, the invention will be described and, explained with additional specificity and, detail through the use of the accompanying drawings in which:

FIG. 1 shows a lighting system comprising C×N lamps, wherein C is a number of channels greater than 2 and N is a number of lamps per channel greater than 2.

### DESCRIPTION OF THE INVENTION

The present disclosure relates generally to a lighting system which operates a plurality of lamps in a pulsed “on” mode rather than a continuous “on” mode.

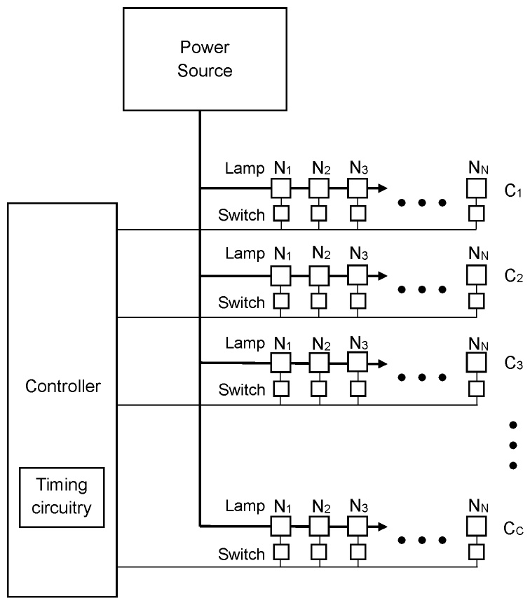

FIG. 1 shows a representative lighting system containing C channels and N lamps per channel. As shown, each channel contains N lamps, numbered as N₁, N₂, N₃, . . . . N_{N}. N is a number greater than 2. In some embodiments, N is a number within the range of 4 to 12. As shown, the channels are numbers as C₁, C₂, C₃ . . . C_{C}. C is a number greater than 2. In some embodiments, C is a number greater than 4.

As shown in FIG. 1, the lighting system includes a power source configured to provide each lamp with an operating power. The operating power comprises an operating current and an operating voltage. In some embodiments, the power source provides a light system operating power comprising a sum of the operating power provided to each lamp in a given time period.

In some embodiments, the lighting system includes a plurality of electronic switches, wherein each lamp is electrically coupled to a corresponding electronic switch. In some embodiments, the plurality of electronic switches comprise a field effect transistor (FET).

In some embodiments of the lighting system, the controller is electrically coupled to the electronic switches via a hard wire connection.

In some embodiments of the lighting system, the controller is electrically coupled to the electronic switches via a wireless connection.

The lighting system includes a controller electrically coupled to the electronic switches. In some embodiments, the controller comprises timing circuitry to control an amount of time each lamp is in the on mode and an amount of time each lamp is in the off mode. In some embodiments, within a given time period, the amount of time each lamp is in the on mode is less than the amount of time each lamp is in the off mode. In some embodiments, the frequency at which each lamp is in the on mode is at least 60 Hz.

In some embodiments of the lighting system, the plurality of lamps comprise LED lamps. In some embodiments of the lighting system, the plurality of lamps comprise incandescent lamps.

In some embodiments, the controller directs each of the C channels in parallel to sequentially operate the N lamps within each channel in the on mode and in the off mode.

In some embodiments, the frequency at which each lamp is in the on mode is in the range of 60 Hz to 1000 Hz. In some embodiments, the frequency at which each lamp is in the on mode is about 60, 100, 200, 300, 400, 500, 600, 700, 800, 900, 1000, 1100 Hz, or more, where any of the stated values can form an upper or lower endpoint of a range.

In some embodiments, each lamp comprises a rated power comprising a rated current and a rated voltage and wherein the operating power exceeds the rated power.

In some embodiments, the lighting system operates at a power savings of 30%. In some embodiments, the lighting system operates at a power savings of 40%. In some embodiments, the lighting system operates at a power savings of 50%. In some embodiments, the lighting system operates at a power savings of 60%. In some embodiments, the lighting system operates at a power savings of 70%. In some embodiments, the lighting system operates at a power savings of 80%. In some embodiments, the lighting system operates at a power savings of 90%.

The controller pulses or switches the lamps “on” and “off” sequentially in a manner which consumes a fraction of the power consumed by the lamps under continuous “on” mode.

The lamps include, but are not limited to, LED lamps and incandescent lamps. Each lamp includes an electronic switch, such as a field effect transistor (FET), which is controlled by the controller and timing circuitry. The electronic switch of each lamp may be directly coupled to the controller via a cable or other hard wire connection. The electronic switch of each lamp may be coupled to the controller via wireless connection.

The lamps are switched “on” and “off” such that the amount of time each lamp is “on” is less than the amount of time the lamp is “off”. Within a given time period, the amount of time the lamp is “on” is less than the amount of time the lamp is “off”. In some embodiments, within a given time period, the amount of time the lamp is “on” is less than 50%, less than 45%, less than 40%, less than 35%, less than 30%, less than 25%, less than 20%, less than 15%, less than 10%, less than 5%, less than 1%, less than 0.5%, less than 0.25%, or less than 0.1%, of the given time period, where any of the stated values can form an upper or lower endpoint of a range.

The voltage and/or current supplied to each lamp during the pulsed “on” mode may be increased compared to the voltage and/or current under normal continuous “on” mode. Increased voltage and/or current permits the lamps to provide greater light output or luminance.

Other features and advantages of the present invention are apparent from the different examples that follow. The examples below illustrate different aspects and embodiments of the present invention and how to make and practice them. The examples do not limit the claimed invention. Although methods and materials similar or equivalent to those described herein can be used in the practice of the present invention, suitable methods and materials are described below. Based on the present disclosure the skilled artisan can identify and employ other components and methodology useful for practicing the present invention.

### Example 1

Four LED lamps, each rated at 4 watts of electrical power, were operated by a motherboard with a microcontroller multiplexing out to four channels that go to a field effect transistor (FET) driver circuit that drives a FET on the low rail of DC power in between power and the LED lamps. The low rail of the DC circuit is the minus side, or next to the ground side of the circuit. Each LED lamp received a positive side voltage of at least 3.5 volts per LED, and the negative side was considered the low side or low rail. The FET transistors functioned as switches to turn individual lamp circuits on and off.

The power supply operated the four 4 watt LED lamps very nicely. Each lamp was pulsed on for 1 millisecond and off for 1 millisecond sequentially. That is, lamp #1 was on for 1 millisecond and off for 1 millisecond, then lamp #2 was on for 1 millisecond and off for 1 millisecond, then #3 was on for 1 millisecond and off for 1 millisecond, and finally lamp #4 was on for 1 millisecond and off for 1 millisecond. Thus, one cycle of the four lamps required 8 milliseconds. The cycle was repeated at total of 125 times per second, i.e., 125 Hz.

To the human eye, each lamp being on at 125 times per second appeared to be continuously on. Light flickering is observed at operating frequencies around 25 Hz and lower. At frequencies of about 50 Hz to 60 Hz and higher, the light appears continuous to the human eye.

Each of the LED lamps was rated at 4 watts of continuous DC electric power (P=VI or 4 watts=(12 volts)×(0.333 amps)). To operate the 4 LED lamps continuously would require 16 watts ((12 volts)×(1.2 amps)).

In this example, each LED lamp was operated in a pulsed “on” mode for 1 millisecond, 125 times per second. Thus, during 1 second, each LED lamp is “on” ⅛ second, reducing the amount of current provided to the LED lamp.

The voltage level may be increased to increase the lumen output to the average level or even beyond the rated lumen value of each lamp. In this example, the voltage was increased to 17.3 volts. Higher voltages such as 20 volts and higher are contemplated. The four lamps were driven at 4 watts ((17.3 volts)×(0.231 amps)).

Another aspect of this disclosure is that by pulsing the LED lamps for just milliseconds at a time, the amount of time each lamp is “on” is a fraction of the time each lamp is “off.” In the above example, each lamp is “on” for only 125 milliseconds during a one second time period, or ⅛ of a second. That means during 24 hours of use, each lamp is only “on” for 3 hours. If the rated life of the LED is 50 thousand hours of continuous use, then the life of the LED according to the disclosed invention may be many times longer, according to the above Example.

Because each LED lamp is pulsed at such a short duration, such as 1 millisecond or shorter, heat generated by the LED lamp is reduced. Even small reductions in operating temperature can increase LED lifespan. The life of semiconductors, including LEDs, running at 20° C. is upwards of 100 thousand hours, but for every one degree over 20° C., such as 21° C., the lifespan is shortened by about one half (50 thousand hours), and if operated at 22° C., the lifespan could be one half again, such as around 25 thousand hours.

### Example 2

While Example 1 only refers to four lamps, it is understood that the disclosed invention may be used to operate many more lamps, even hundreds more.

For example, 32 lamps each rated at 12 volts, were operated at 16 watts at 111.6 Hz and 8% duty cycle, were connected into 4 channels of 8 lamps each. Each channel would sequentially turn on one of the lamps in the respective channel at the same time. So, each of the 4 channels would turn on lamp #1 at the same time, then lamp #2 at the same time, then lamp #s 3, 4, 5, 6, 7, and 8 sequentially, so that one lamp from each of the four channels was on at the same time. Each channel would cycle each of the eight lamps on for a short period of 120 microseconds and off for 1000 microseconds, at a frequency of 111.6 times per second at 8% duty cycle. Thus, four lamps were on at one time, then sequenced through all of the eight lamps. This was found to maintain the brightness of each of the lamps to the human eye. Also note that the timing was continually adjusted for maximum brightness while power of 60 watts remained the same. It was also noted that the preferred timing can be adjusted to provide an on time period greater than 120 microseconds and the off time can be adjusted to provide an off time period less than 1000 microseconds, so that frequency can be lower, such as 60 times a second, for the whole system of 32 lamps.

It was determined that by turning on only one lamp, of the 32 lamps, at a time, the brightness would decrease by factor of 32 times, making it harder to increase voltages. Since LEDs are DC devices, higher voltages could burn out the LEDs in the microsecond domain. So, it was discovered that keeping the multiplex, or round robin effect, down to eight or less for each channel would permit the voltage to be increased slightly, which would increase brightness without burning out the LEDs. For example, operating LED at 15 volts instead of 12 volts. Adding more lamps would be a matter of adding more channels, to increase 10s to 100s of lamps. Each channel would have up to ten lamps, with eight or fewer lamps being preferred on each channel. All channels would run one lamp at the same time.

By running the lamps greater than 60 times a second, such as 111.6 times a second in this example, the lamps appear to be continuously “on” to the human eye.

Furthermore, the pulse duration is not limited to millisecond domain pulses. Pulse durations in the microsecond domain are currently preferred. Pulse durations in the nanosecond and even picosecond domains would require higher voltages, such as 100 to 500 volts per LED. Pulses running below about 10 nanoseconds would utilize a capacity that charges during the “off” mode and then discharges a large amount of current into a LED during the “on” pulse. A pulse in the picosecond domain would utilize a higher voltage compared to a pulse in the nanosecond domain.

### Example 3

The operation of a 32 LED lamp system in a pulsed “on” system was compared to the operation of the 32 LED lamp in continuous “on” system.

Each LED lamp consisted of a 12-volt LED light bar having 120 LED chips per lamp made by Capetronix. The power regulator used to minimize power and current, common in some commercially available LED lamps to prevent LED damage from excessive current operating current, was removed from each LED lamp used for 32 LED lamp pulse system, so that a true pulse width modulated current could be used during the pulse process.

The 32 lamps were connected into 4 channels of 8 lamps each. Each channel would sequentially turn on one of the lamps in the respective channel at the same time. So, each of the 4 channels would turn on lamp #1 at the same time, then lamp #2 at the same time, then lamp #3 at the same time, then lamp numbers 4, 5, 6, 7, and 8 sequentially at the same time, so that one lamp from each of the four channels was on at the same time.

The pulse system timing board was adjusted so that each LED lamp was on for a total period of 1880 microseconds and then off for 0.1316 seconds. Only 1 out of the 8 lamps in each channel was on at a given time. That means that lamp #1 was on for 1880 microseconds, then lamp #2 was on for 1880 microseconds, then lamp #3 was on for 1880 microseconds, and so on until lamp #8 was on for 1880 microseconds, then the cycle repeated with lamp #1 on for 1880 microseconds. The 4 channels of 8 lamps per channel were operated in a round robin cycle at a frequency of 66.5 Hz. This means that the 8 lamps in each channel were on for a total time of 0.01504 seconds per second. At a frequency of 66.5 Hz, the LED lamps appeared to be on continuously. This cycle timing and frequency eliminated dead time, or the time between lamps being off. This meant that in each channel of 8 lamps, one lamp was always “on”. By decreasing the amount of time the lamps were off and increasing the time the lamps were on, the light output or Lux was increased. It is within the scope of the disclosure to operate the LED lamps for shorter “on” time periods and even longer “off” time periods, but doing so will reduce the Lux light output.

The operating power of the pulsed LED lamps was adjusted to 40 watts (the lowest the power supply could go) and increase the lux output power.

The Lux measurement per LED lamp on a 1 cm square detector for the pulse 32 LED lamp system was found to be an average of 6850 Lux operating at 40 watts, as measured by a power meter.

The Lux measurement per LED lamp on a lem square detector for the continuous 32 LED lamps was found to be an average of 5400 Lux operating at 150 watts, as measured by a power meter.

The results show that the pulse system power savings was 110 watts compared to the continuous power of 150 watts. This represents a power savings of about 73.3%(110 watts/150 watts), while producing 1.2 times the Lux output (6850/5400).

If one normalizes the light output of the pulse system compared to the continuous system, the same amount of light output (5400 Lux) could be obtained using 33.3 watts for the pulse system compared to the 150 watts of the continuous system, which represents a power savings of about 116.7 watts. Thus, if one compares substantially equal light output, then the power savings would be about 77.8%(116.7 watts/150 watts).

The process can be used on many more LED lamps than 32 lamps. Also, it was found by extrapolating the data, that by running fewer than 8 lamps per channel, then the time each lamp is “on” can be increased, which can produce higher Lux output.

For example, by running 4 lamps across per 16 channels for 64 lamps, this can increase the Lux output by a factor of about 4. The reason for this result is because when 4 lamps are pulsed in each channel instead of 8 lamps, there is 4 times more dead time “off”′ which can be used to increase the time “on” for the remaining 4 lamps. This increases the Lux output by a factor of about 4×. This then enables the power input to be decreased to 8 watts to keep the LED lamps from blowing due to excess power. This embodiment can result in power savings of about 142 watts, which represents a power savings of about 94.6%(142 watts/150 watts) for the same Lux output.

Preferably, the microsecond pulse domain is more practical due to commercially available, low-cost microcontrollers and electronic latches and logic chips that can be operated in the microsecond time domain. Also because LED lamps are DC devices, operating them in the microsecond time domain limits the current from blowing out the LED lamps. The microsecond domain of 1 to 50 microseconds also maintains the proper current in the lamps to maintain a good brightness or high lumens output for higher voltage lamps.

The disclosed invention is particularly adapted to provide a lighting system for big box stores and warehouses that typically have a hundred or more ceiling lights, each operating at 35 watts to 50 watts. Higher power level lamps such as 100 to 500-watt lamps are conceivable for large warehouses and production plants. For example, 400 ceiling lights are not uncommon in such buildings. Each of the lights can be pulsed for an “on” duration from about 150 microseconds depending on the lamp to about 2 milliseconds, as in the above example. The lights can be pulsed for an “off” duration from about 971 microseconds or as desired to achieve a required light output. The operating frequency can be adjusted from 60 Hz to much higher frequencies in a manner similar to the examples described above. Each of the 400 lights would be “on” at a frequency sufficiently high for the lights to appear to be “on” continuously. At 60 Hz, the lights will appear to be “on” continuously to the human eye.

The power required to operate the 400 ceiling lamps in the disclosed pulsed system is significantly less than the power required to operate all the lamps in a continuous mode.

This example would require 50 channels of eight lamps per channel. In some embodiments, the power savings could be as much as 87.5% while using only 12.5%. In this case one lamp in each of the 50 channels would be on at the same time as each of the 50 channels cycles through their eight lamps at the same time. Only one lamp per channel would be on at one time, so 50 lamps would be on as the controller cycles through all 400 lamps.

For example, to run 32 led lamps at 15 watts each would use 480 watts of power for all 32 lamps, however running four led lamps on at the same time would use 60 watts of power, and would run all 32 lamps at 60 watts power while using only 8 times less power or 12.5% of the energy to operate the lamps continuously. This savings can be high as 90% and even to 96% depending on how many lamps are operated per channel, for example an increase from eight lamps per channel to ten lamps per channel would increase the efficiency to 90% savings, but this would limit each lamp's lumen output. This increase of lamps per channel can be done by sacrificing brightness and lumens. This decrease of lumen output can be offset by increasing the operating voltage and by increasing the pulse width or pulse duration to a point in which become longer than the overall cycle of the system, thereby decreasing pulses below 60 Hz within the lamp. The user can determine whether to operate the lamps for higher brightness and lumens or for lower brightness and lumens, and corresponding higher power savings. For example, lamps operated for higher brightness lumens can be placed in a parking garage or warehouses and lamps operated for lower brightness and lumens can be placed in grocery stores which can provide higher power savings.

Assuming the lamps are incandescent lamps, each lamp would operate at an increased DC voltage, so that the output lumens is increased.

Most LED lamps have a step-down or buck converter or an AC to DC converter. It was determined to remove these converters and run directly to the channels in the example above with an appropriate voltage source.

Those who use industrial lighting LED lamps operate them at voltages, such as 208, 240, or 280 volts, and directly drive many hundreds of LEDs within one lamp, thereby eliminating the need for power converters. These lamps would not be operated at an increased voltage according to the present disclosure, but they could be operated with a longer pulse duration to increase current pulse within the lamp thereby increasing brightness and lumens. This lighting system would preferably limit each channel to eight or fewer lamps, and preferably 4 lamps per channel while maintaining an operating frequency greater than 60 Hz.

Operating four lamps per channel would decrease the power efficiency down to 50%, but these types of industrial lighting lamps could be programmed internally to have a longer pulse on time period and operate at a higher power. For example, instead of operating at 47 to 50 watts per lamp, an internal microcontroller could increase the operating power to 150 watts per lamp. Moreover, if each channel includes eight lamps, the percentage is increased back up to 87.5%. This would reduce the operating frequency of 892 times per second down to above 60 times a second. Thus, by adjusting the number of lamps per channel, the pulse duration, and operating frequency, the end user can balance the desired brightness and lumens of the operating lamps with the desired operating power savings.

In some embodiments, each lamp would have a field effect transistor (FET) as a switch either on the low side of the DC power supply or on the high side of the DC power rails.

In some embodiments, each lamp could have a small control circuit board connected into the lamp. The board may have a FET and a FET driver. The circuit board may have at least two CAT 5 sockets so it can plug into the next lamp in series, up to eight lamps. And a cable to connect one channel to the next channel to run 8 other lamps and so on. CAT 5 cables have eight lines and a ground shield, so they would have eight signal lines and a ground plane. CAT 5 cables may be used to connect eight lamps, each lamp getting one signal line and a ground return. One CAT 5 cable may connect to and control up to eight lamps. To operate 400 lamps, 50 CAT 5 cables connected to the motherboard controller would be needed. Or each lamp would have its own board that communicates to the next lamp without a mother board.

In some embodiments, each of the FETs may be isolated by an optical driver isolating the control circuit board voltage to the lamp's high voltages. Each circuit board would get its power from either an AC to DC converter or a capacitor dropper circuit to run an internal board without a main mother board to run all lamps, which is preferred due to the simple circuitry and low cost.

In some embodiments, the circuit board may also have a capacitor dropper circuit, which means it gets its power from the AC line feeding the lamp. A 2-microfarad capacitor is in series with AC mains and goes into a small bridge rectifier chip, just four diodes that converts AC 60 Hz line to DC. As an example, 120 volts AC is converted to lower voltage DC and a 15-volt Zener diode is placed on the DC output that makes sure the DC voltage is regulated at 15 volts to run the FET driver on the output side. This could be one way to internally power a driver in each lamp. Other embodiments could use a voltage regulator chip to power internal circuitry.

In some embodiments, the FET may be included into the low side of the LED.

In some embodiments, each circuit board can communicate to a central controller (motherboard) either by CAT 5 cables (or other cable method).

In some embodiments, the circuit board can communicate to the central controller (motherboard) by wireless communication such as X-10 or Z-wave that communicates through existing AC wiring or other wireless communication technologies such a Bluetooth or conventional WiFi protocols (IEEE 802.11 family of standards).

Another aspect of some embodiments of the disclosed lighting system can utilize a microprocessor coupled to each lamp which would communicate to the next lamp in line to turn on the turn off the lamp. This is a preferred and easy to implement lighting system at the OEM level of manufacturing the way the voltage levels could be controlled for each lamp and also case of installing the lamps in the stores.

Another example of the disclosed lighting system may operate multiple lamps using a motherboard with one processor running 4 eight-bit latches for a total of 4 CAT 5 cables, yielding 32 signal lines going out to multiple lamps. Each lamp has a small switch board installed between the DC power supply and LEDs in the lamp. The signal can be TTL (logic level voltage) or higher voltage. 12 volts would be preferred. The voltage signal turns the FET driver on and off, this is done for each lamp, up to 32 lamps due to maximum capacity on the motherboard. This method uses cables and one microprocessor which can be important due to world chip shortage.

Eight bit latches used are one of many they have eight ports input and eight ports output and a latch enable pinout, this way a microprocessor can put a 5 volt on one of the eight pins and a high of latch enable pin then once the 5 volts is in the input the latch goes low and the 5 volts is locked in on the output side. This way one can control up to eight latches (chips) or more at a time without interfering with others. For example, the microprocessor has (A port with eight signal lines, B port with eight signal lines, C port with eight signal lines, and D port with four lines). One may use the C port and each eight lines goes to four latches (4 chips). Then one uses the D port form the microprocessor to connect to latch enable on the latch chips so each one of the latch chips are individually controlled. The C port which has eight pinouts from the microprocessor now can control 32 complete outputs or more, that can run the FET drivers. If one can put more latches on, then one can run many more outputs because each latch is one channel. One may also increase operation capacity with a microprocessor that has 40 pinouts, which can control hundreds of outputs.

The choice of implementing a lighting system using one motherboard or many motherboards may be affected by microprocessor availability and cost. It is also within the scope of the disclosed invention for each lamp to have its own microcontroller and internal circuitry to communicate with other lamps in the channel, so no motherboard is required. Instead, each channel of lamps would communicate to the other channels of lamps using this invention.

It is within the scope of the disclosed invention to operate more than 400 lamps.

While this disclosure has been particularly shown and described with references to certain embodiments thereof, it will be understood by those skilled in the art that features of the disclosed invention may be combined in different variations, not expressly disclosed above. In other words, it will be understood that the foregoing disclosure is not limited in any way to merely specific embodiments expressly disclosed. Various changes in form and details may be made therein without departing from the scope of the disclosure encompassed by the appended claims.

1. A lighting system comprising:
a plurality of lamps configured to operate in an on mode and in an off mode, wherein the plurality of lamps comprise C×N lamps, wherein C is a number of channels greater than 2 and N is a number of lamps per channel greater than 2;
a plurality of electronic switches, wherein each lamp is electrically coupled to a corresponding electronic switch;
a power source configured to provide each lamp with an operating power comprising an operating current and an operating voltage, wherein the power source provides a light system operating power comprising a sum of the operating power provided to each lamp in a given time period; and
a controller electrically coupled to the electronic switches, wherein the controller comprises timing circuitry to control an amount of time each lamp is in the on mode and an amount of time each lamp is in the off mode, wherein within a given time period, the amount of time each lamp is in the on mode is less than the amount of time each lamp is in the off mode, and wherein the frequency at which each lamp is in the on mode is at least 60 Hz.

2. The lighting system of claim 1, wherein the controller is electrically coupled to the electronic switches via a hard wire connection.

3. The lighting system of claim 1, wherein the controller is electrically coupled to the electronic switches via a wireless connection.

4. The lighting system of claim 1, wherein the plurality of lamps comprise LED lamps.

5. The lighting system of claim 1, wherein the plurality of lamps comprise incandescent lamps.

6. The lighting system of claim 1, wherein the plurality of electronic switches comprise a field effect transistor (FET).

7. The lighting system of claim 1, wherein within a given time period, the amount of time each lamp is in the on mode is less than 20% the amount of time each lamp is in the off mode.

8. The lighting system of claim 1, wherein within a given time period, the amount of time each lamp is in the on mode is less than 15% the amount of time each lamp is in the off mode.

9. The lighting system of claim 1, wherein within a given time period, the amount of time each lamp is in the on mode is less than 10% the amount of time each lamp is in the off mode.

10. The lighting system of claim 1, wherein within a given time period, the amount of time each lamp is in the on mode is less than 5% the amount of time each lamp is in the off mode.

11. The lighting system of claim 1, wherein the frequency at which each lamp is in the on mode is in the range of 60 Hz to 1000 Hz.

12. The lighting system of claim 1, wherein each lamp comprises a rated power comprising a rated current and a rated voltage and wherein the operating power exceeds the rated power.

13. The lighting system of claim 1, wherein the lighting system operates at a power savings of 50%.

14. The lighting system of claim 1, wherein the lighting system operates at a power savings of 70%.

15. The lighting system of claim 1, wherein the lighting system operates at a power savings of 90%.

16. The lighting system of claim 1, wherein C is a number greater than 4.

17. The lighting system of claim 1, wherein N is a number within the range of 4 to 12.

18. The lighting system of claim 1, wherein the controller directs each of the C channels in parallel to sequentially operate the N lamps within each channel in the on mode and in the off mode.
